(19) United States
(12) Patent Application Publication
(10) Pub. No.: US 2025/0220265 A1
(43) Pub. Date: Jul. 3, 2025

(54) DISPLAY CONTROL DEVICE AND DISPLAY CONTROL METHOD

(71) Applicant: Panasonic Automotive Systems Co., Ltd., Kanagawa (JP)

(72) Inventors: Kazuki ONISHI, Osaka (JP); Yusuke HIRAGA, Kanagawa (JP); Takeshi ITO, Kanagawa (JP); Shintaro TSUBATA, Kanagawa (JP); Kazunori TANAKA, Kanagawa (JP)

(73) Assignee: Panasonic Automotive Systems Co., Ltd., Kanagawa (JP)

(21) Appl. No.: 18/986,981

(22) Filed: Dec. 19, 2024

(30) Foreign Application Priority Data
Dec. 28, 2023 (JP) 2023-222864

(51) Int. Cl. H04N 21/431

(52) U.S. Cl. CPC H04N 21/4318; H04N 21/4314; H04N 21/4316

(57) ABSTRACT

A display control device includes: a display content selector that, when a malfunctioning display is detected, selects, based on a priority level for display set for each of a plurality of items of display content, one or more items of display content for which the priority level is higher among the plurality of items of display content; and a display position determiner that determines, based on a tolerance level for a display position change set for each of the plurality of items of display content, a display position in one or more displays, to cause a displacement of display content for which the tolerance level is lower among the one or more items of display content to be smaller, the displacement being a displacement from a position at which the same display content had been displayed before the malfunctioning display was detected.

### CROSS REFERENCE TO RELATED APPLICATION

The present application is based on and claims priority of Japanese Patent Application No. 2023-222864 filed on Dec. 28, 2023.

### FIELD

The present disclosure relates to a display control device and the like.

### BACKGROUND

A device and the like which control the display of an image in a display have been disclosed in the past. For example, Patent Literature (PTL) 1 discloses a display device including a malfunction detector/automatic notifier that detects a screen malfunction, and a display priority level determiner that determines information content to be displayed, and a display position thereof, in a properly-functioning display screen after the screen malfunction, based on a screen malfunction notification from the malfunction detector/automatic notifier, information on a malfunctioning screen position, and a display priority level set by a display priority level setter.

### CITATION LIST

### Patent Literature

PTL 1: Japanese Patent No. 5395557

### SUMMARY

However, the display device according to PTL 1 can be improved upon.

In view of this, the present disclosure provides a display control device and the like capable of further improving upon the related art.

A display control device according to one aspect of the present disclosure includes: a detector that detects a malfunctioning display that has malfunctioned from among a plurality of displays; a display content selector that, when the malfunctioning display is detected, selects, based on a priority level for display set for each of a plurality of items of display content displayed in the plurality of displays before the malfunctioning display was detected, one or more items of display content for which the priority level is higher among the plurality of items of display content; a display position determiner that determines, based on a tolerance level for a display position change set for each of the plurality of items of display content, a display position of each of the one or more items of display content in one or more of the plurality of displays aside from the malfunctioning display, to cause a displacement of display content for which the tolerance level is lower among the one or more items of display content to be smaller, the displacement being a displacement from a position at which a corresponding one of the one or more items of display content had been displayed before the malfunctioning display was detected; and a display switcher that causes each of the one or more items of display content to be displayed at the display position of a corresponding one of the one or more items of display content.

Additionally, a display control method according to one aspect of the present disclosure includes: detecting a malfunctioning display that has malfunctioned from among a plurality of displays; when the malfunctioning display is detected, selecting, based on a priority level for display set for each of a plurality of items of display content displayed in the plurality of displays before the malfunctioning display was detected, one or more items of display content for which the priority level is higher among the plurality of items of display content;

determining, based on a tolerance level for a display position change set for each of the plurality of items of display content, a display position of each of the one or more items of display content in one or more of the plurality of displays aside from the malfunctioning display, to cause a displacement of display content for which the tolerance level is lower among the one or more pieces of display content to be smaller, the displacement being a displacement from a position at which a corresponding one of the one or more items of display content had been displayed before the malfunctioning display was detected; and causing each of the one or more items of display content to be displayed at the display position of a corresponding one of the one or more items of display content.

Additionally, a program according to one aspect of the present disclosure is a program that causes a computer to execute the above-described display control method.

Note that these comprehensive or specific aspects may be realized by a system, a method, an integrated circuit, a computer program, or a computer-readable recording medium such as a CD-ROM, or may be implemented by any desired combination of systems, methods, integrated circuits, computer programs, and recording media. The recording medium may also be a non-transitory recording medium.

The display control device and the like according to the present disclosure are capable of further improving upon the related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a schematic diagram illustrating a plurality of displays according to an embodiment.

FIG. 2 is a block diagram illustrating the functional configuration of a display control device and the like according to the embodiment.

FIG. 3 is a flowchart illustrating an example of a display control method performed by the display control device illustrated in FIG. 1.

FIG. 4 is a flowchart illustrating an example of operations performed in step S4 of FIG. 3.

FIG. 5 is a flowchart illustrating an example of operations performed in step S8 of FIG. 3.

FIG. 6 is a first explanatory diagram illustrating an example of the operations illustrated in FIGS. 4 and 5.

FIG. 7 is a second explanatory diagram illustrating an example of the operations illustrated in FIGS. 4 and 5.

FIG. 8 is a table showing an example of priority levels and tolerance levels.

FIG. 9 is a third explanatory diagram illustrating an example of the operations illustrated in FIGS. 4 and 5.

FIG. 10 is a fourth explanatory diagram illustrating an example of the operations illustrated in FIGS. 4 and 5.

FIG. 11 is a table showing another example of priority levels and tolerance levels.

### DESCRIPTION OF EMBODIMENTS

With the display device disclosed in PTL 1, there is a problem that it is difficult to reduce displacement of the display position of information content for which the display position is to be maintained to the greatest extent possible between before and after a screen malfunction is detected.

Accordingly, a display control device according to one aspect of the present disclosure includes: a detector that detects a malfunctioning display that has malfunctioned from among a plurality of displays; a display content selector that, when the malfunctioning display is detected, selects, based on a priority level for display set for each of a plurality of items of display content displayed in the plurality of displays before the malfunctioning display was detected, one or more items of display content for which the priority level is higher among the plurality of items of display content; a display position determiner that determines, based on a tolerance level for a display position change set for each of the plurality of items of display content, a display position of each of the one or more items of display content in one or more of the plurality of displays aside from the malfunctioning display, to cause a displacement of display content for which the tolerance level is lower among the one or more items of display content to be smaller, the displacement being a displacement from a position at which a corresponding one of the one or more items of display content had been displayed before the malfunctioning display was detected; and a display switcher that causes each of the one or more items of display content to be displayed at the display position of a corresponding one of the one or more items of display content.

According to this configuration, one or more items of display content having a higher priority level among the plurality of items of display content can be selected, and the one or more items of display content selected can be displayed in one or more of the plurality of displays aside from the malfunctioning display. Accordingly, when a malfunctioning display is detected, display content to be displayed preferentially among the plurality of items of display content can be displayed with ease. Additionally, the display position can be determined such that displacement of display content from the position at which the same display content was displayed before the malfunctioning display was detected is made smaller for display content, among the one or more items of display content, for which the tolerance level is lower. Accordingly, displacement can be easily made smaller for the display position of display content for which the display position is to be maintained to the greatest extent possible between before and after the malfunctioning display is detected.

In this manner, when a malfunctioning display is detected, display content to be displayed preferentially among the plurality of items of display content can be displayed with ease, and displacement can be easily made smaller for the display position of display content for which the display position is to be maintained to the greatest extent possible between before and after the malfunctioning display is detected.

Additionally, in the display control device according to one aspect of the present disclosure, the display content selector may select the one or more items of display content to make an area of one or more images indicating the one or more items of display content, and having a same size as an image that indicated same display content before the malfunctioning display was detected, no greater than an area of a display region of the one or more of the plurality of displays. The display position determiner may determine the display position of each of the one or more items of display content by determining a position in the one or more of the plurality of displays to cause a displacement of an image indicating the display content for which the tolerance level is lower among the one or more images to be smaller, the displacement being a displacement from a position at which an image indicating the corresponding one of the one or more items of display content had been displayed before the malfunctioning display was detected. The display switcher may cause each of the one or more items of display content to be displayed at the display position of the corresponding one of the one or more items of display content by causing each of the one or more images to be displayed at the position determined.

According to this, one or more items of display content can easily be selected, and the display position of each of the one or more items of display content can easily be determined, by using one or more images indicating the one or more items of display content, and having the same size as an image that indicated the same display content before the malfunctioning display was detected. Accordingly, when a malfunctioning display is detected, display content to be displayed preferentially among the plurality of items of display content can be displayed with further ease, and displacement can be even more easily made smaller for the display position of display content for which the display position is to be maintained to the greatest extent possible between before and after the malfunctioning display is detected.

Additionally, in the display control device according to one aspect of the present disclosure, the display content selector may select the one or more items of display content to make an area of one or more images indicating one or more items of display content, and at least one of which is a reduced image obtained by reducing an image that indicated same display content before the malfunctioning display was detected or a replacement image replacing the image that indicated the same display content before the malfunctioning display was detected, no greater than an area of a display region of the one or more of the plurality of displays. The display position determiner may determine the display position of the one or more items of display content by determining a position in the one or more of the plurality of displays to cause a displacement of an image indicating the display content for which the tolerance level is lower among the one or more images to be smaller, the displacement being a displacement from a position at which an image indicating the corresponding one of the one or more items of display content had been displayed before the malfunctioning display was detected. The display switcher may cause each of the one or more items of display content to be displayed at the display position of the corresponding one of the one or more items of display content by causing each of the one or more images to be displayed at the position determined.

According to this, one or more items of display content can easily be selected, and the display position of each of the one or more items of display content can easily be determined, by using one or more images indicating one or more items of display content, and at least one of which is a reduced image obtained by reducing an image that indicated the same display content before the malfunctioning display was detected or a replacement image replacing the image that indicated the same display content before the malfunctioning display was detected. Accordingly, when a malfunctioning display is detected, display content to be displayed preferentially among the plurality of items of display content can be displayed with further ease, and displacement can be even more easily made smaller for the display position of display content for which the display position is to be maintained to the greatest extent possible between before and after the malfunctioning display is detected.

Additionally, in the display control device according to one aspect of the present disclosure, when the malfunctioning display recovers, the display switcher may cause each of the plurality of items of display content to be displayed at a position where the corresponding one of the plurality of items of display content had been displayed before the malfunctioning display was detected.

According to this, when the malfunctioning display recovers, each of the plurality of items of display content can be displayed at positions where the corresponding ones of the plurality of items of display content were displayed before the malfunctioning display was detected.

Additionally, in the display control device according to one aspect of the present disclosure, the plurality of displays may include at least one of a display that is disposed in front of a driver's seat of the vehicle and that displays two or more items of display content among the plurality of items of display content, a display that is disposed in front of a passenger seat of the vehicle and that displays two or more items of display content among the plurality of items of display content, a display that is included in an electronic side mirror on a right side of the vehicle and that displays one item of display content among the plurality of items of display content, a display that is included in an electronic side mirror on a left side of the vehicle and that displays one item of display content among the plurality of items of display content, a display that is included in an electronic rear-view mirror of the vehicle and that displays one item of display content among the plurality of items of display content, or a display that is provided for a rear seat of the vehicle and that displays one or more items of display content among the plurality of items of display content.

According to this, when the malfunctioning display is detected from any one of the plurality of displays including at least one of the display disposed in front of the driver's seat of the vehicle, the display disposed in front of the passenger seat of the vehicle, the display included in the electronic side mirror on the right side of the vehicle, the display included in the electronic side mirror on the left side of the vehicle, the display included in the electronic rear-view mirror of the vehicle, or the display disposed for the rear seat of the vehicle, display content to be displayed preferentially among the plurality of items of display content can be displayed with ease, and displacement can be even more easily made smaller for the display position of display content for which the display position is to be maintained to the greatest extent possible between before and after the malfunctioning display is detected, in one or more of the plurality of displays aside from the malfunctioning display.

Additionally, a display control method according to one aspect of the present disclosure includes: detecting a malfunctioning display that has malfunctioned from among a plurality of displays; when the malfunctioning display is detected, selecting, based on a priority level for display set for each of a plurality of items of display content displayed in the plurality of displays before the malfunctioning display was detected, one or more items of display content for which the priority level is higher among the plurality of items of display content; determining, based on a tolerance level for a display position change set for each of the plurality of items of display content, a display position of each of the one or more items of display content in one or more of the plurality of displays aside from the malfunctioning display, to cause a displacement of display content for which the tolerance level is lower among the one or more pieces of display content to be smaller, the displacement being a displacement from a position at which a corresponding one of the one or more items of display content had been displayed before the malfunctioning display was detected; and causing each of the one or more items of display content to be displayed at the display position of a corresponding one of the one or more items of display content.

This provides the same effects as the display control device described above.

Additionally, a program according to one aspect of the present disclosure is a program that causes a computer to execute the above-described display control method.

This provides the same effects as the display control device described above.

An embodiment of the present disclosure will be described hereinafter with reference to the drawings.

Note that the following embodiment describes a comprehensive or specific example of the present disclosure. The numerical values, shapes, materials, constituent elements, arrangements and connection states of constituent elements, steps, orders of steps, and the like in the following embodiment are merely examples, and are not intended to limit the present disclosure. Additionally, of the constituent elements in the following embodiment, constituent elements not denoted in the independent claims will be described as optional constituent elements. Additionally, the drawings are schematic diagrams, and are not necessarily exact illustrations. In the drawings, constituent elements which are the same are given the same reference signs.

### Embodiment

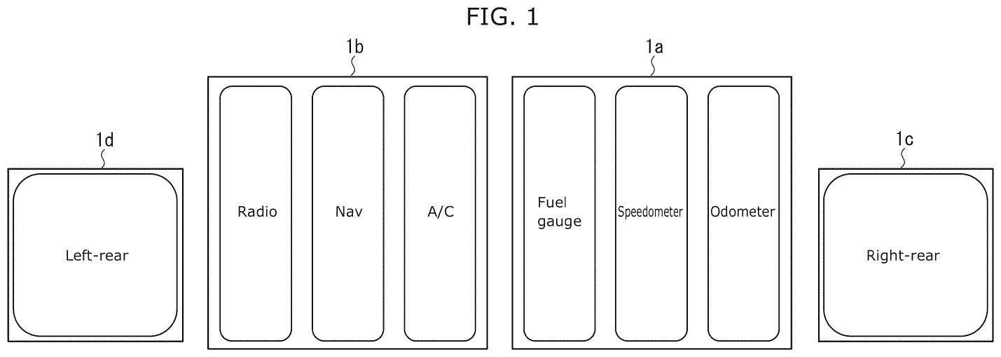

FIG. 1 is a schematic diagram illustrating a plurality of displays 1a to 1d according to the embodiment. FIG. 1 schematically illustrates a state in which the plurality of displays 1a to 1d are viewed from a rear side of a vehicle in which the plurality of displays 1a to 1d are installed. The plurality of displays 1a to 1d will be described first with reference to FIG. 1.

The plurality of displays 1a to 1d are installed in the vehicle. The vehicle is an automobile or the like, for example.

Display 1a is disposed in front of the driver's seat of the vehicle. Display 1a displays display content toward the rear side of the vehicle. Here, display 1a displays two or more items of display content among a plurality of items of display content, and the two or more items of display content are displayed side-by-side in a horizontal direction of the vehicle. The two or more items of display content are content related to an odometer, content related to a speedometer, and content related to a fuel gauge.

Display 1b is disposed in front of the passenger seat of the vehicle, and is disposed to the left of display 1a. Display 1b displays display content toward the rear side of the vehicle. Here, display 1b displays two or more items of display content among the plurality of items of display content, and the two or more items of display content are displayed side-by-side in the horizontal direction of the vehicle. The two or more items of display content are content related to an air conditioner, content related to navigation, and content related to a radio.

Display 1c is provided in an electronic side mirror on the right side of the vehicle, and is disposed to the right of display 1a. Display 1c displays display content toward the rear side of the vehicle. Here, display 1c displays one item of display content among the plurality of items of display content. The one item of display content is content of an image captured of the area to the right-rear of the vehicle.

Display 1d is provided in an electronic side mirror on the left side of the vehicle, and is disposed to the left of display 1b. Display 1d displays display content toward the rear side of the vehicle. Here, display 1d displays one item of display content among the plurality of items of display content. The one item of display content is content of an image captured of the area to the left-rear of the vehicle.

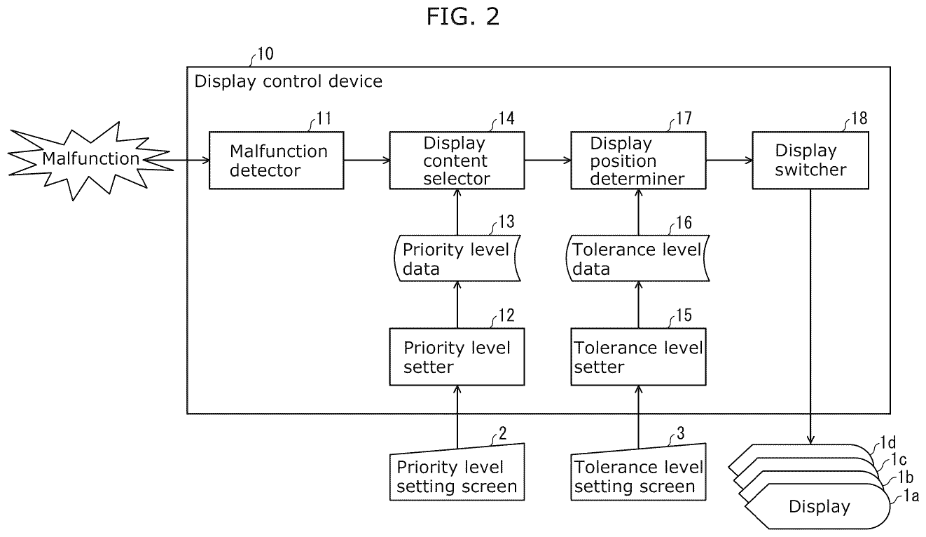

FIG. 2 is a block diagram illustrating the functional configuration of display control device 10 and the like according to the embodiment. The functional configuration of display control device 10 and the like will be described next with reference to FIG. 2.

As illustrated in FIG. 2, display control device 10 includes malfunction detector 11, priority level setter 12, priority level data 13, display content selector 14, tolerance level setter 15, tolerance level data 16, display position determiner 17, and display switcher 18. For example, malfunction detector 11 is implemented by a sensor or the like, and priority level setter 12, display content selector 14, tolerance level setter 15, display position determiner 17, and display switcher 18 are implemented by a processor, a memory, and the like. In the present embodiment, display control device 10 is installed in the vehicle. Malfunction detector 11 detects a malfunctioning display, which is a display among the plurality of displays 1a to 1d that has malfunctioned. For example, malfunction detector 11 is connected to each of the plurality of displays 1a to 1d, and when any one of the plurality of displays 1a to 1d is unable to display the display content correctly, malfunction detector 11 detects the display that is unable to display the display content correctly as a malfunctioning display.

Priority level setter 12 sets a priority level for display, input from priority level setting screen 2, and outputs priority level data 13 indicating the priority level set. For example, priority level setting screen 2 is displayed in display 1a or display 1b, and accepts an input of the priority level of each of the plurality of items of display content. Priority level setter 12 then sets the priority level of each of the plurality of items of display content.

When a malfunctioning display is detected, display content selector 14 selects one or more items of display content, among the plurality of items of display content, having a higher priority level, based on the priority level for display set for each of the plurality of items of display content that had been displayed in the plurality of displays 1a to 1d before the malfunctioning display was detected. In other words, display content selector 14 selects one or more items of display content among the plurality of items of display content, in order from the display content having the highest priority level. For example, when three items of display content among the plurality of items of display content are to be selected, display content selector 14 selects the display content having the highest priority level, the display content having the second-highest priority level, and the display content having the third-highest priority level, among the plurality of items of display content.

For example, display content selector 14 selects the one or more items of display content such that an area of one or more images indicating the one or more items of display content, and having the same size as a corresponding image that indicated the same display content before the malfunctioning display was detected, is no greater than an area of a display region of one or more of the displays.

Additionally, for example, display content selector 14 selects the one or more items of display content such that a size of one or more images indicating one or more items of display content, and at least one of which is a reduced image obtained by reducing an image that indicated the same display content before the malfunctioning display was detected or a replacement image replacing the image that indicated the same display content before the malfunctioning display was detected, is no greater than a size of the display region of one or more of the displays.

Tolerance level setter 15 sets a tolerance level of a display position change input from tolerance level setting screen 3, and outputs tolerance level data 16 indicating the tolerance level set. For example, tolerance level setting screen 3 is displayed in display 1a or display 1b, and accepts an input of the tolerance level of each of the plurality of items of display content. Tolerance level setter 15 then sets the tolerance level of each of the plurality of items of display content.

Based on the tolerance level for the display position change set for each of the plurality of items of display content, display position determiner 17 determines a display position in one or more of the plurality of displays 1a to 1d aside from the malfunctioning display to cause the displacement of the display content, from the position at which the same display content had been displayed before the malfunctioning display was detected, to be smaller for display content having a lower tolerance level among the one or more items of display content selected by display content selector 14. In other words, display position determiner 17 determines the display position in order from the display content having the lowest tolerance level among the one or more items of display content. For example, when three items of display content are selected by display content selector 14, display position determiner 17 determines the display position of the display content having the lowest tolerance level among the three items of display content to cause the displacement from the position where the same display content had been displayed before the malfunctioning display was detected to be smaller, determines the display position of the display content having the second-lowest tolerance level to cause the displacement from the position where the same display content had been displayed before the malfunctioning display was detected to be smaller, and then determines the display position of the display content having the third-lowest tolerance level to cause the displacement from the position where the same display content had been displayed before the malfunctioning display was detected to be smaller. If, for each of the one or more items of display content, the display content can be displayed at the same position where the same display content had been displayed before the malfunctioning display was detected, display position determiner 17 determines the display position such that the display content can be displayed at the same position. However, if, for each of the one or more items of display content, the display content cannot be displayed at the same position where the same display content had been displayed before the malfunctioning display was detected, display position determiner 17 determines the display position such that the display content can be displayed at a position as close as possible to the same position.

For example, display position determiner 17 determines the display position of each of the one or more items of display content by determining a position in the one or more displays to cause the displacement of an image, from a position at which an image indicating the same display content had been displayed before the malfunctioning display was detected, to be smaller for an image, among the one or more images indicating the one or more items of display content, indicating display content having a lower tolerance level. For example, when three items of display content are selected by display content selector 14, display position determiner 17 determines the position of the image, among three images indicating the three items of display content, that indicates the display content having the lowest tolerance level to cause the displacement from the position where an image indicating the same display content had been displayed before the malfunctioning display was detected to be smaller, determines the position of the image indicating the display content having the second-lowest tolerance level to cause the displacement from the position where an image indicating the same display content had been displayed before the malfunctioning display was detected to be smaller, and then determines the position of the image indicating the display content having the third-lowest tolerance level to cause the displacement from the position where an image indicating the same display content had been displayed before the malfunctioning display was detected to be smaller.

For example, when the number of the one or more items of display content is represented by N, each of the one or more items of display content is represented by display content i (1≤ i≤N), the position of display content i before the malfunctioning display is detected is represented by (xᵢ, yᵢ), the position of display content i after the malfunctioning display is detected is represented by (x′ᵢ, y′ᵢ), and the tolerance level of display content i is represented by aᵢ, display position determiner 17 determines the position of display content i after the malfunctioning display is detected so as to minimize evaluation function L expressed by the following Formula (1).

$$[ Math 1 ]$$

$$L = {\sum }_{i = 1}^{N} \{ {( {x}_{i}^{′} - {x}_{i} )}^{2} + {( {y}_{i}^{′} - {y}_{i} )}^{2} \} / {a}_{i} \qquad ( 1 )$$

Display switcher 18 causes each of the one or more items of display content selected by display content selector 14 to be displayed at the display position of that item of display content determined by display position determiner 17.

For example, display switcher 18 causes each of the one or more items of display content to be displayed at the display position of that item of display content by causing each of the one or more images indicating the one or more items of display content to be displayed at the determined position.

Additionally, for example, display switcher 18 causes each of the one or more items of display content to be displayed at the display position of that item of display content by causing each of the one or more images indicating the one or more items of display content (i) to be displayed as a replacement image at the determined position when the image is determined to be set to a replacement image, (ii) to be displayed at a reduced size at the determined position when the image is determined to be reduced, and (iii) to be displayed as-is at the determined position when the image is determined to be used as-is.

Additionally, for example, when the malfunctioning display recovers, display switcher 18 causes each of the plurality of items of display content to be displayed at positions where the corresponding ones of the plurality of items of display content had been displayed before the malfunctioning display was detected.

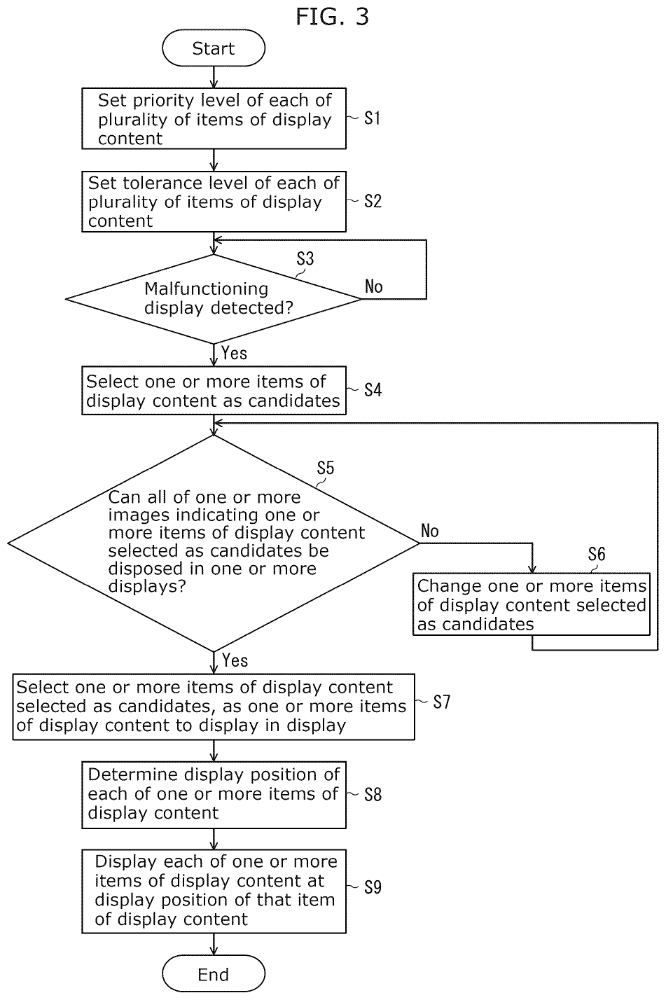

FIG. 3 is a flowchart illustrating an example of a display control method performed by display control device 10 illustrated in FIG. 1. An example of a display control method performed by display control device 10 will be described next with reference to FIG. 3.

As illustrated in FIG. 3, priority level setter 12 sets the priority level of each of the plurality of items of display content (step S1). Tolerance level setter 15 sets the tolerance level of each of the plurality of items of display content (step S2). Note that step S1 may be performed before step S2.

Display content selector 14 determines whether a malfunctioning display has been detected by malfunction detector 11 (a detection step) (step S3).

If a malfunctioning display has not been detected by malfunction detector 11 (No in step S3), display content selector 14 again determines whether a malfunctioning display has been detected by malfunction detector 11 (step S3).

When a malfunctioning display is detected by malfunction detector 11 (Yes in step S3), display content selector 14 selects, as candidates, one or more items of display content having a higher priority level among the plurality of items of display content, based on the priority level for display set for each of the plurality of items of display content that had been displayed in the plurality of displays 1a to 1d before the malfunctioning display was detected (step S4). For example, display content selector 14 may select one or more items of display content aside from the display content having the lowest priority level among the plurality of items of display content.

Display content selector 14 determines whether all of the one or more images indicating the one or more items of display content selected as candidates can be disposed in one or more displays (step S5). In other words, display content selector 14 determines whether the one or more images indicating the one or more items of display content selected as candidates will fit in a display region of the one or more displays.

If all of the one or more images indicating the one or more items of display content selected as candidates cannot be disposed in the one or more displays (No in step S5), display content selector 14 changes the one or more items of display content selected as candidates (step S6). For example, display content selector 14 changes the display content to one or more items of display content aside from the display content having the lowest priority level among the one or more items of display content selected in step S4.

If all of the one or more images indicating the one or more items of display content selected as candidates can be disposed in the one or more displays (Yes in step S5), display content selector 14 selects the one or more items of display content selected as candidates as one or more items of display content to be displayed in the one or more displays (step S7).

In this manner, display content selector 14 selects one or more items of display content as candidates, and if all of one or more images indicating the one or more items of display content selected as candidates can be disposed in the one or more displays, selects the one or more items of display content selected as candidates as the one or more items of display content to be displayed in the one or more displays (display content selection steps) (steps S4 to S7).

Display position determiner 17 determines the display position of each of the one or more items of display content based on the tolerance level for the display position change set for each of the plurality of items of display content (a display position determination step) (step S8). Specifically, based on the tolerance level for the display position change set for each of the plurality of items of display content, display position determiner 17 determines a display position in one or more of the plurality of displays 1a to 1d aside from the malfunctioning display to cause the displacement of the display content, from the position at which the same display content had been displayed before the malfunctioning display was detected, to be smaller for display content having a lower tolerance level among the one or more of items of display content.

Display switcher 18 causes each of the one or more items of display content to be displayed at the display position of that display content (a display switching step) (step S9), after which the sequence ends.

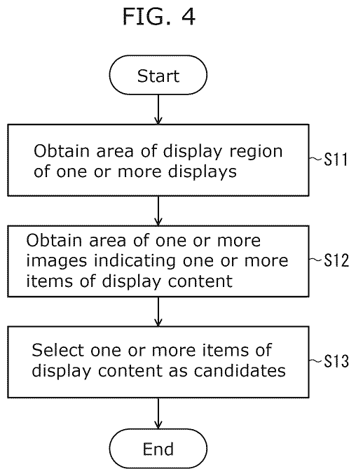

FIG. 4 is a flowchart illustrating an example of the operations performed in step S4 of FIG. 3. An example of the operations performed in step S4 of FIG. 3 will be described next with reference to FIG. 4.

As illustrated in FIG. 4, display content selector 14 obtains the area of the display region of the one or more displays (step S11). For example, the areas of the respective display regions of the plurality of displays 1a to 1d are stored in advance, for example, by being input to display control device 10.

Display content selector 14 obtains the area of one or more images indicating one or more items of display content (step S12). For example, display content selector 14 obtains the area of each of the one or more images indicating the one or more items of display content from image data or the like for forming the corresponding one of the one or more images indicating the one or more items of display content. Note that step S12 may be performed before step S11.

Display content selector 14 selects one or more items of display content as candidates such that the area of the one or more images indicating the one or more items of display content is no greater than the area of the display region of the one or more displays (step S13), after which the sequence ends.

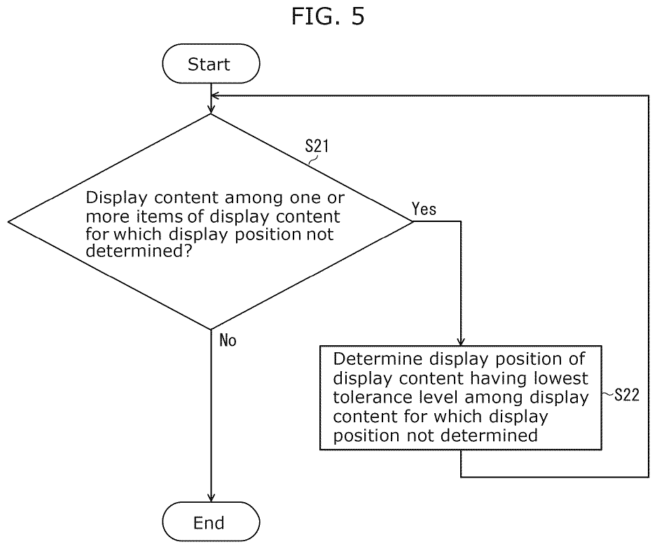

FIG. 5 is a flowchart illustrating an example of the operations performed in step S8 of FIG. 3. An example of the operations performed in step S8 of FIG. 3 will be described next with reference to FIG. 5.

As illustrated in FIG. 5, display position determiner 17 determines whether display content for which the display position has not been determined is present among the one or more items of display content (step S21).

If display content for which the display position has not been determined is present among the one or more items of display content (Yes in step S21), display position determiner 17 determines the position of the display content having the lowest tolerance level among the display content for which the display position has not been determined (step S22). Specifically, display position determiner 17 determines the display position of the display content to cause the displacement of the display content from the position where the same display content had been displayed before the malfunctioning display was detected to be smaller.

If display content for which the display position has not been determined is not present among the one or more items of display content (No in step S21), display position determiner 17 ends the sequence.

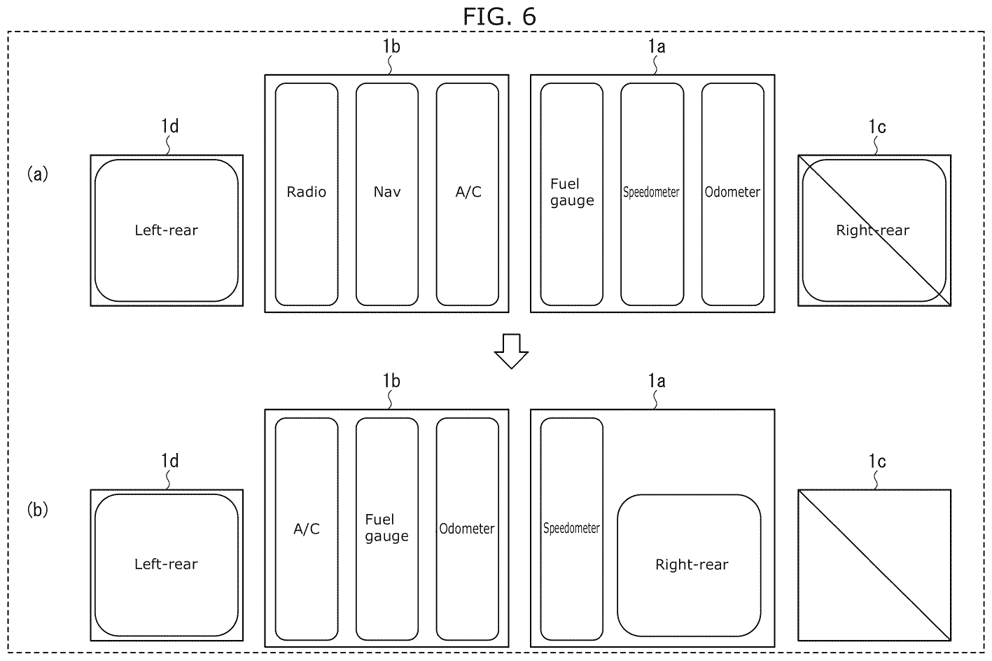

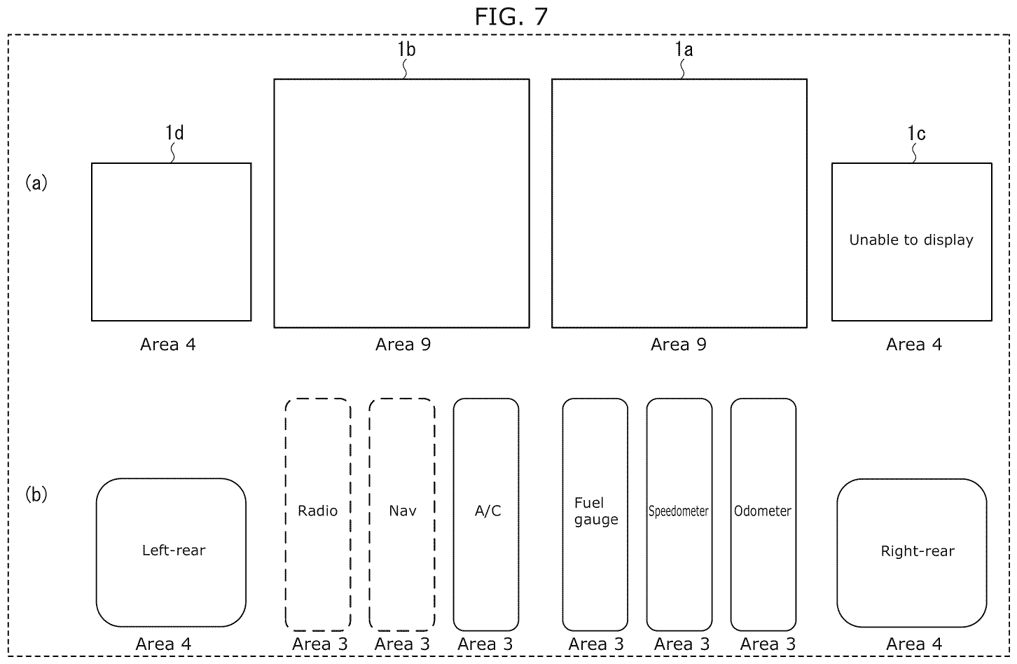

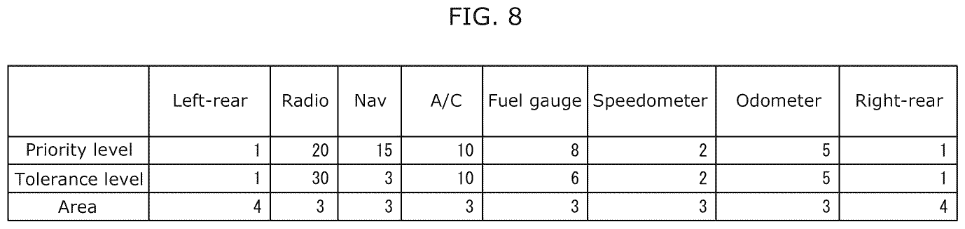

FIG. 6 is a first explanatory diagram illustrating an example of the operations illustrated in FIGS. 4 and 5. FIG. 7 is a second explanatory diagram illustrating an example of the operations illustrated in FIGS. 4 and 5. FIG. 8 is a table showing an example of priority levels and tolerance levels. An example of the operations illustrated in FIGS. 4 and 5 will be described next with reference to FIGS. 7 to 9.

As indicated in (a) of FIG. 6, when display 1c malfunctions, malfunction detector 11 detects display 1c as the malfunctioning display.

As indicated in (a) of FIG. 7, when the malfunctioning display is detected, display content selector 14 obtains the area of the display region of the one or more displays 1a, 1b, and 1d. Additionally, as indicated in (b) of FIG. 7, display content selector 14 obtains the area of each of the plurality of images indicating the plurality of items of display content. Here, the priority levels and tolerance levels are set as illustrated in FIG. 8. A lower number indicates a higher priority level. On the other hand, a lower number indicates a low tolerance level. Returning to FIG. 7, display content selector 14 determines one or more items of display content such that the area of the one or more images is no greater than the area of the display region of the one or more displays 1a, 1b, and 1d. The area of the one or more displays 1a, 1b, and 1d is 22, and thus display content selector 14 selects six items of display content having higher priority levels (content of an image captured of the area to the right-rear of the vehicle, content of an image captured of the area to the left-rear of the vehicle, content pertaining to the speedometer, content pertaining to the odometer, content pertaining to the fuel gauge, and content pertaining to the air conditioner), such that the area is no greater than 22.

As indicated in (b) of FIG. 6, display position determiner 17 determines the display positions in the one or more displays 1a, 1b, and 1d to cause the displacement of the display content, from the position at which the same display content had been displayed before the malfunctioning display was detected, to be smaller for the image, among the one or more images, indicating display content for which the tolerance level is lower.

First, display position determiner 17 sets the position of the image indicating the content of an image captured of the area to the right-rear, which has the lowest tolerance level, to the positions at which the image indicating content pertaining to the odometer and the image indicating content pertaining to the speedometer had been displayed in display 1a, to cause the displacement from the position at which the image indicating the same display content had been displayed before the malfunction (in display 1c) to be smaller. Additionally, display position determiner 17 sets the position of the image indicating the content pertaining to the left-rear, which has the lowest tolerance level, in display 1d to cause the displacement of that position from the position at which the image indicating the same display content had been displayed before the malfunction (in display 1d) to be smaller. Next, display position determiner 17 sets the position of the image indicating the content pertaining to the speedometer, which has the second-lowest tolerance level, to the position at which the image indicating the content pertaining to the fuel gauge had been displayed in display 1a, to cause the displacement from the position at which the image indicating the same display content had been displayed before the malfunction to be smaller. Likewise, display position determiner 17 sets the positions of the images indicating the content pertaining to the odometer, the content pertaining to the fuel gauge, and the content pertaining to the air conditioner, in that order.

Display switcher 18 causes the six items of the display content to be displayed in the one or more displays 1a, 1b, and 1d by causing the six images indicating the six items of display content to be displayed at the positions set. Note that when display 1c recovers, display switcher 18 causes each of the plurality of items of display content to be displayed at positions where those items of display content were displayed before the malfunctioning display was detected, as indicated in (a) of FIG. 6.

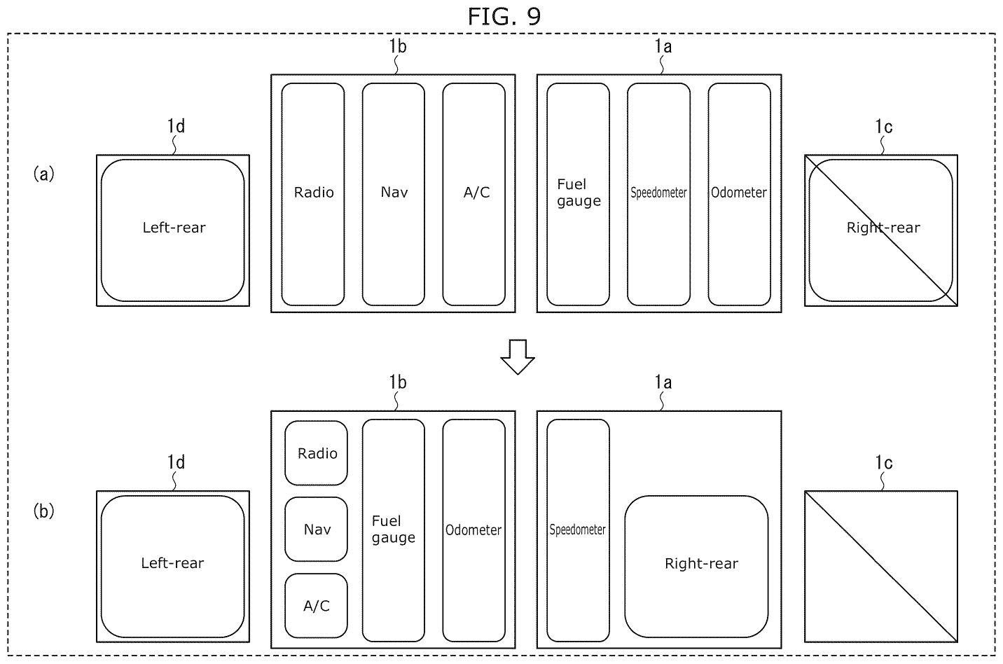

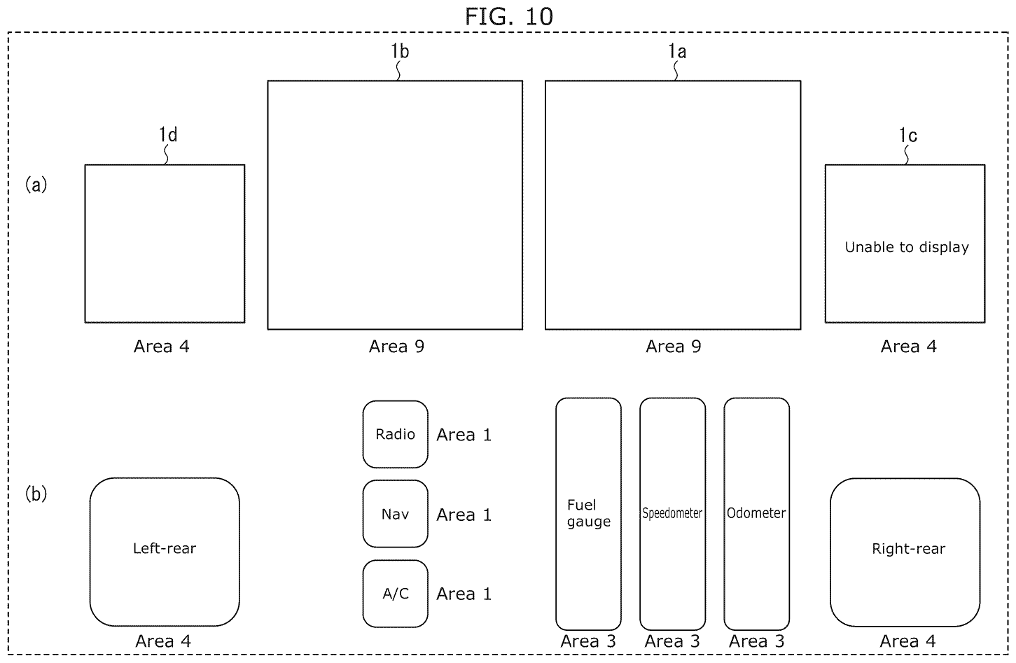

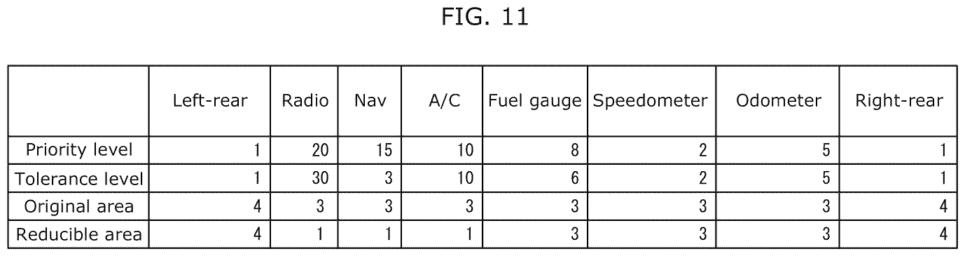

FIG. 9 is a third explanatory diagram illustrating an example of the operations illustrated in FIGS. 4 and 5. FIG. 10 is a fourth explanatory diagram illustrating an example of the operations illustrated in FIGS. 4 and 5. FIG. 11 is a table showing another example of priority levels and tolerance levels. An example of the operations illustrated in FIGS. 4 and 5 will be described next with reference to FIGS. 8 to 11.

Here, the priority levels and tolerance levels are set as illustrated in FIG. 11. For each of the plurality of items of display content, a minimum value for which the area can be reduced (a reducible area) when the image is displayed in a reduced manner is stored in addition to the area of the image in which the display content was displayed before the malfunctioning display was detected (an original area). The image may be reduced to any desired area as long as that area is at least the reducible area. In other words, the image is not reduced to an area that would be less than the reducible area.

As indicated in (a) of FIG. 9, when display 1c malfunctions, malfunction detector 11 detects display 1c as the malfunctioning display.

As indicated in (a) of FIG. 10, when the malfunctioning display is detected, display content selector 14 obtains the area of the display region of the one or more displays 1a, 1b, and 1d. Additionally, as indicated in (b) of FIG. 10, display content selector 14 obtains the area of each of the plurality of images indicating the plurality of items of display content. Here, the images indicating the three items of display content having the lower priority levels (the content pertaining to the radio, the content pertaining to navigation, and the content pertaining to the air conditioner) can be reduced (see FIG. 11), and the sizes of reduced images reduced compared to the image that had indicated the same content before the malfunctioning display was detected are obtained. Display content selector 14 determines the one or more items of display content such that the area of one or more images including the reduced images is no greater than the area of the display region of the one or more displays 1a, 1b, and 1d. Note that when the reduced image of a given image becomes lower than the reducible area, display content selector 14 determines that the image is not to be displayed as a reduced image. Here, the area of the one or more displays 1a, 1b, and 1d is 22, and thus display content selector 14 selects eight items of display content having higher priority levels (content of an image captured of the area to the right-rear of the vehicle, content of an image captured of the area to the left-rear of the vehicle, content pertaining to the speedometer, content pertaining to the odometer, content pertaining to the fuel gauge, content pertaining to the air conditioner, content pertaining to navigation, and content pertaining to the radio), such that the area is no greater than 22. Note that the image indicating content pertaining to the radio may be omitted from the one or more images, and the image indicating content pertaining to the air conditioner or the image indicating content pertaining to navigation may be displayed slightly larger.

As indicated in (b) of FIG. 9, display position determiner 17 determines the display positions in the one or more displays 1a, 1b, and 1d such that the displacement of the display content from the position at which the same display content was displayed before the malfunctioning display was detected is made smaller for the image, among the one or more images, indicating display content for which the tolerance level is lower.

Here, display position determiner 17 sets the position of each of the three images indicating the three items of display content having lower priority levels to the position at which the image indicating the content pertaining to the radio was displayed in display 1b, to cause the displacement from the position at which the images indicating the same content were displayed before the malfunction to be smaller. Display position determiner 17 sets the position of each of the three images such that the three images are arranged in a vertical direction.

Display switcher 18 causes the eight items of the display content to be displayed in the one or more displays 1a, 1b, and 1d by causing the eight images indicating the eight items of display content to be displayed at the positions set. Note that when display 1c recovers, display switcher 18 causes each of the plurality of items of display content to be displayed at positions where those items of display content were displayed before the malfunctioning display was detected, as indicated in (a) of FIG. 9.

Note that if, for each of the plurality of items of display content, a replacement image is present for the image that indicated that display content before the malfunctioning display was detected, the area of the replacement image may be stored. In this case, for example, display content selector 14 obtains the area of the replacement images for the display content for which the replacement images are present, and determines the one or more items of display content such that the area of one or more images including the replacement images is no greater than the area of the display region of the one or more displays 1a, 1b, and 1d. The area of the replacement image is different from the area of the image that indicated the same display content before the malfunctioning display was detected. Note that if the area of the one or more images including the replacement images will not be greater than the area of the display region of the one or more of displays 1a, 1b, and 1d, display content selector 14 will not display the replacement images for those images.

Additionally, if, for each of the plurality of items of display content, a reduced image and a replacement image are both present, either the reduced image or the replacement image may be selected preferentially, the smaller of the reduced image and the replacement image may be selected, or one of the reduced image and the replacement image may be selected through a predetermined method.

Display control device 10 according to the present embodiment includes: malfunction detector 11 that detects a malfunctioning display that has malfunctioned from among the plurality of displays 1a to 1d; display content selector 14 that, when the malfunctioning display is detected, selects, based on a priority level for display set for each of a plurality of items of display content displayed in the plurality of displays 1a to 1d before the malfunctioning display was detected, one or more items of display content for which the priority level is higher among the plurality of items of display content; display position determiner 17 that determines, based on a tolerance level for a display position change set for each of the plurality of items of display content, a display position of each of the one or more items of display content in one or more of the plurality of displays 1a to 1d aside from the malfunctioning display, to cause a displacement of display content for which the tolerance level is lower among the one or more items of display content to be smaller, the displacement being a displacement from a position at which a corresponding one of the one or more items of display content had been displayed before the malfunctioning display was detected; and display switcher 18 that causes each of the one or more items of display content to be displayed at the display position of a corresponding one of the one or more items of display content.

According to this configuration, one or more items of display content having a higher priority level among the plurality of items of display content can be selected, and the one or more items of display content selected can be displayed in one or more of the plurality of displays aside from the malfunctioning display. Accordingly, when a malfunctioning display is detected, display content to be displayed preferentially among the plurality of items of display content can be displayed with ease. Additionally, the display position can be determined such that displacement of display content from the position at which the same display content was displayed before the malfunctioning display was detected is made smaller for display content, among the one or more items of display content, for which the tolerance level is lower. Accordingly, displacement can be easily made smaller for the display position of display content for which the display position is to be maintained to the greatest extent possible between before and after the malfunctioning display is detected. In this manner, when a malfunctioning display is detected, display content to be displayed preferentially among the plurality of items of display content can be displayed with ease, and displacement can be easily made smaller for the display position of display content for which the display position is to be maintained to the greatest extent possible between before and after the malfunctioning display is detected.

Additionally, in display control device 10 according to the present embodiment, display content selector 14 selects the one or more items of display content to make an area of one or more images indicating the one or more items of display content, and having a same size as an image that indicated same display content before the malfunctioning display was detected, no greater than an area of a display region of the one or more of the plurality of displays. Display position determiner 17 determines the display position of each of the one or more items of display content by determining a position in the one or more of the plurality of displays to cause a displacement of an image indicating the display content for which the tolerance level is lower among the one or more images to be smaller, the displacement being a displacement from a position at which an image indicating the corresponding one of the one or more items of display content had been displayed before the malfunctioning display was detected. Display switcher 18 causes each of the one or more items of display content to be displayed at the display position of the corresponding one of the one or more items of display content by causing each of the one or more images to be displayed at the position determined.

According to this, one or more items of display content can easily be selected, and the display position of each of the one or more items of display content can easily be determined, by using one or more images indicating the one or more items of display content, and having the same size as an image that indicated the same display content before the malfunctioning display was detected. Accordingly, when a malfunctioning display is detected, display content to be displayed preferentially among the plurality of items of display content can be displayed with further ease, and displacement can be even more easily made smaller for the display position of display content for which the display position is to be maintained to the greatest extent possible between before and after the malfunctioning display is detected.

Additionally, in display control device 10 according to the present embodiment, display content selector 14 selects the one or more items of display content to make an area of one or more images indicating one or more items of display content, and at least one of which is a reduced image obtained by reducing an image that indicated same display content before the malfunctioning display was detected or a replacement image replacing the image that indicated the same display content before the malfunctioning display was detected, no greater than an area of a display region of the one or more of the plurality of displays. Display position determiner 17 determines the display position of the one or more items of display content by determining a position in the one or more of the plurality of displays to cause a displacement of an image indicating the display content for which the tolerance level is lower among the one or more images to be smaller, the displacement being a displacement from a position at which an image indicating the corresponding one of the one or more items of display content had been displayed before the malfunctioning display was detected. Display switcher 18 causes each of the one or more items of display content to be displayed at the display position of the corresponding one of the one or more items of display content by causing each of the one or more images to be displayed at the position determined.

According to this, one or more items of display content can easily be selected, and the display position of each of the one or more items of display content can easily be determined, by using one or more images indicating one or more items of display content, and at least one of which is a reduced image obtained by reducing an image that indicated the same display content before the malfunctioning display was detected or a replacement image replacing the image that indicated the same display content before the malfunctioning display was detected. Accordingly, when a malfunctioning display is detected, display content to be displayed preferentially among the plurality of items of display content can be displayed with further ease, and displacement can be even more easily made smaller for the display position of display content for which the display position is to be maintained to the greatest extent possible between before and after the malfunctioning display is detected.

Additionally, in display control device 10 according to the present embodiment, when the malfunctioning display recovers, display switcher 18 causes each of the plurality of items of display content to be displayed at a position where the corresponding one of the plurality of items of display content had been displayed before the malfunctioning display was detected.

According to this, when the malfunctioning display recovers, each of the plurality of items of display content can be displayed at positions where the corresponding ones of the plurality of items of display content were displayed before the malfunctioning display was detected.

Additionally, in display control device 10 according to the present embodiment, the plurality of displays 1a to 1d includes display 1a that is disposed in front of the driver's seat of the vehicle and that displays two or more items of display content among the plurality of items of display content, display 1b that is disposed in front of a passenger seat of the vehicle and that displays two or more items of display content among the plurality of items of display content, display 1c that is included in an electronic side mirror on a right side of the vehicle and that displays one item of display content among the plurality of items of display content, and display 1d that is included in an electronic side mirror on a left side of the vehicle and that displays one item of display content among the plurality of items of display content.

According to this, when the malfunctioning display is detected from among display 1a disposed in front of the driver's seat of the vehicle, display 1b disposed in front of the passenger seat of the vehicle, display 1c included in the electronic side mirror on the right side of the vehicle, and display 1d included in the electronic side mirror on the left side of the vehicle, display content to be displayed preferentially among the plurality of items of display content can be displayed with ease, and displacement can be even more easily made smaller for the display position of display content for which the display position is to be maintained to the greatest extent possible between before and after the malfunctioning display is detected, in one or more of the plurality of displays aside from the malfunctioning display.

Additionally, a display control method according to the present embodiment includes: detecting a malfunctioning display that has malfunctioned from among the plurality of displays 1a to 1d (step S3); when the malfunctioning display is detected, selecting, based on a priority level for display set for each of a plurality of items of display content displayed in the plurality of displays 1a to 1d before the malfunctioning display was detected, one or more items of display content for which the priority level is higher among the plurality of items of display content (steps S4 to S7); determining, based on a tolerance level for a display position change set for each of the plurality of items of display content, a display position of each of the one or more items of display content in one or more of the plurality of displays 1a to 1d aside from the malfunctioning display, to cause a displacement of display content for which the tolerance level is lower among the one or more pieces of display content to be smaller, the displacement being a displacement from a position at which a corresponding one of the one or more items of display content had been displayed before the malfunctioning display was detected (step S8); and causing each of the one or more items of display content to be displayed at the display position of a corresponding one of the one or more items of display content (step S9).

This provides the same effects as display control device 10 described above.

Additionally, a program according to the present embodiment is a program that causes a computer to execute the above-described display control method.

This provides the same effects as display control device 10 described above.

### Other Embodiments, Etc.

A display control device and the like according to one or more aspects have been described thus far based on an embodiment, but the present disclosure is not limited to the embodiment. Various conceivable variations made on the present embodiment by one skilled in the art also fall within the scope of the present disclosure as long as those variations do not depart from the essential spirit of the present disclosure.

Although the foregoing embodiment described a case where the plurality of displays 1a to 1d are provided in a vehicle, the configuration is not limited thereto. For example, the plurality of displays may be disposed in the interior of a building or the like.

Additionally, although the foregoing embodiment described a case where the plurality of displays 1a to 1d are provided in a vehicle, the configuration is not limited thereto. For example, the plurality of displays may include at least one of display 1a, display 1b, display 1c, display 1d, a display included in an electronic rear-view mirror of the vehicle and displaying one item of display content among a plurality of items of display content, or a display disposed for a rear seat of the vehicle and displaying one or more items of display content among the plurality of items of display content. For example, the display content displayed in the display included in the electronic rear-view mirror is content of an image captured of the area behind the vehicle or the like. Additionally, for example, the display disposed for the rear seat is provided in a ceiling or the like of the vehicle, and is disposed at a position visible from the rear seat. Additionally, for example, as long as a plurality of displays are disposed in the vehicle, the display for the driver's seat or the like may be omitted, or the display for the passenger seat or the like may be omitted.

In the foregoing embodiment, the constituent elements are constituted by dedicated hardware. However, the constituent elements may be realized by executing software programs corresponding to those constituent elements. Each constituent element may be realized by a program executing unit such as a Central Processing Unit (CPU) or a processor reading out and executing a software program recorded on a recording medium such as a hard disk or semiconductor memory. Here, the software that implements the device and the like according to the above-described embodiment is a program that causes a computer to execute each step included in the flowchart illustrated in FIGS. 3, 4, 5, and 11.

Note that the present disclosure is also inclusive of the following cases.

(1) Each of the above-described devices is specifically a computer system constituted by a microprocessor, ROM, RAM, a hard disk unit, a display unit, a keyboard, a mouse, and the like. A computer program is stored in the RAM, ROM, or hard disk unit. Each device realizes the functions thereof by the microprocessor operating in accordance with the computer program. Here, the computer program is constituted by a combination of a plurality of command codes that indicate commands made to a computer to achieve a predetermined function.

(2) Some or all of the constituent elements constituting the above-described devices may be implemented by a single integrated circuit through system LSI (Large-Scale Integration). “System LSI” refers to very-large-scale integration in which multiple constituent elements are integrated on a single chip, and specifically, refers to a computer system configured including a microprocessor, ROM, RAM, and the like. A computer program is stored in the RAM or the ROM. The system LSI circuit realizes the functions thereof by the microprocessor operating in accordance with the computer program.

(3) Some or all of the constituent elements constituting the foregoing devices may be constituted by IC cards or stand-alone modules that can be removed from and mounted in the device. The IC card or the module is a computer system constituted by a microprocessor, ROM, RAM, and the like. The IC card or module may include the above very-large-scale integration LSI circuit. The IC card or module realizes the functions thereof by the microprocessor operating in accordance with the computer program. The IC card or module may be tamper-resistant.

(4) The present disclosure may be realized by the methods described above. This may be a computer program that implements these methods on a computer, or a digital signal constituting the computer program.

Additionally, the present disclosure may also be computer programs or digital signals recorded in a computer-readable recording medium such as a flexible disk, a hard disk, a CD-ROM, an MO, a DVD, a DVD-ROM, a DVD-RAM, a BD (Blu-ray (registered trademark) Disc), semiconductor memory, or the like, for example. The constituent elements may also be the digital signals recorded in such a recording medium.

Additionally, the present disclosure may be realized by transmitting the computer program or digital signal via a telecommunication line, a wireless or wired communication line, a network such as the Internet, a data broadcast, or the like.

The present disclosure may also be a computer system including a microprocessor and a memory, where the memory stores the above-described computer program and the microprocessor operates in accordance with the computer program.

The present invention may also be implemented by another independent computer system, by recording the program or the digital signal in the recording medium and transferring the recording medium, or by transferring the program or the digital signal over the network or the like.

(5) The above-described embodiment may be combined with other aspects.

### Supplement

The following techniques are disclosed by the descriptions in the foregoing embodiment and the like.

### Technique 1

A display control device including:
a detector that detects a malfunctioning display that has malfunctioned from among a plurality of displays;
a display content selector that, when the malfunctioning display is detected, selects, based on a priority level for display set for each of a plurality of items of display content displayed in the plurality of displays before the malfunctioning display was detected, one or more items of display content for which the priority level is higher among the plurality of items of display content;
a display position determiner that determines, based on a tolerance level for a display position change set for each of the plurality of items of display content, a display position of each of the one or more items of display content in one or more of the plurality of displays aside from the malfunctioning display, to cause a displacement of display content for which the tolerance level is lower among the one or more pieces of display content to be smaller, the displacement being a displacement from a position at which a corresponding one of the one or more items of display content had been displayed before the malfunctioning display was detected; and
a display switcher that causes each of the one or more items of display content to be displayed at the display position of a corresponding one of the one or more items of display content.

### Technique 2

The display control device according to Technique 1,
wherein the display content selector selects the one or more items of display content to make an area of one or more images indicating the one or more items of display content, and having a same size as an image that indicated same display content before the malfunctioning display was detected, no greater than an area of a display region of the one or more of the plurality of displays,
the display position determiner determines the display position of the one or more items of display content by determining a position in the one or more of the plurality of displays to cause a displacement of an image indicating the display content for which the tolerance level is lower among the one or more images to be smaller, the displacement being a displacement from a position at which an image indicating the corresponding one of the one or more items of display content had been displayed before the malfunctioning display was detected, and
the display switcher causes each of the one or more items of display content to be displayed at the display position of the corresponding one of the one or more items of display content by causing each of the one or more images to be displayed at the position determined.

### Technique 3

The display control device according to Technique 1, wherein the display content selector selects the one or more items of display content to make an area of one or more images indicating one or more items of display content, and at least one of which is a reduced image obtained by reducing an image that indicated same display content before the malfunctioning display was detected or a replacement image replacing the image that indicated the same display content before the malfunctioning display was detected, no greater than an area of a display region of the one or more of the plurality of displays,
the display position determiner determines the display position of the one or more items of display content by determining a position in the one or more of the plurality of displays to cause a displacement of an image indicating the display content for which the tolerance level is lower among the one or more images to be smaller, the displacement being a displacement from a position at which an image indicating the corresponding one of the one or more items of display content had been displayed before the malfunctioning display was detected, and
the display switcher causes each of the one or more items of display content to be displayed at the display position of the corresponding one of the one or more items of display content by causing each of the one or more images to be displayed at the position determined.

### Technique 4

The display control device according to any one of Techniques 1 to 3,
wherein when the malfunctioning display recovers, the display switcher causes each of the plurality of items of display content to be displayed at a position where the corresponding one of the plurality of items of display content had been displayed before the malfunctioning display was detected.

### Technique 5

The display control device according to any one of Techniques 1 to 4,
wherein the plurality of displays includes at least one of a display that is disposed in front of a driver's seat of the vehicle and that displays two or more items of display content among the plurality of items of display content, a display that is disposed in front of a passenger seat of the vehicle and that displays two or more items of display content among the plurality of items of display content, a display that is included in an electronic side mirror on a right side of the vehicle and that displays one item of display content among the plurality of items of display content, a display that is included in an electronic side mirror on a left side of the vehicle and that displays one item of display content among the plurality of items of display content, a display that is included in an electronic rear-view mirror of the vehicle and that displays one item of display content among the plurality of items of display content, or a display that is provided for a rear seat of the vehicle and that displays one or more items of display content among the plurality of items of display content.

### Technique 6

A display control method including:
detecting a malfunctioning display that has malfunctioned from among a plurality of displays;
when the malfunctioning display is detected, selecting, based on a priority level for display set for each of a plurality of items of display content displayed in the plurality of displays before the malfunctioning display was detected, one or more items of display content for which the priority level is higher among the plurality of items of display content;
determining, based on a tolerance level for a display position change set for each of the plurality of items of display content, a display position of each of the one or more items of display content in one or more of the plurality of displays aside from the malfunctioning display, to cause a displacement of display content for which the tolerance level is lower among the one or more pieces of display content to be smaller, the displacement being a displacement from a position at which a corresponding one of the one or more items of display content had been displayed before the malfunctioning display was detected; and
causing each of the one or more items of display content to be displayed at the display position of a corresponding one of the one or more items of display content.

### Technique 7

A program that causes a computer to execute the display control method according to Technique 6.

While various embodiments have been described herein above, it is to be appreciated that various changes in form and detail may be made without departing from the spirit and scope of the present disclosure as presently or hereafter claimed.

### Further Information about Technical Background to this Application

The disclosure of the following patent application including specification, drawings, and claims are incorporated herein by reference in their entirety: Japanese Patent Application No. 2023-222864 filed on Dec. 28, 2023.

### INDUSTRIAL APPLICABILITY

The present disclosure can be used in devices and the like that control the display of images in a display.

1. A display control device comprising:
a memory; and
a processor connected to the memory, the processor being configured to execute:
detection processing for detecting a malfunctioning display that has malfunctioned from among a plurality of displays;
display content selection processing for, when the malfunctioning display is detected, selecting, based on a priority level for display set for each of a plurality of items of display content displayed in the plurality of displays before the malfunctioning display was detected, one or more items of display content for which the priority level is higher among the plurality of items of display content;
display position determination processing for determining, based on a tolerance level for a display position change set for each of the plurality of items of display content, a display position of each of the one or more items of display content in one or more of the plurality of displays aside from the malfunctioning display, to cause a displacement of display content for which the tolerance level is lower among the one or more pieces of display content to be smaller, the displacement being a displacement from a position at which a corresponding one of the one or more items of display content had been displayed before the malfunctioning display was detected; and
display switching processing for causing each of the one or more items of display content to be displayed at the display position of a corresponding one of the one or more items of display content.

2. The display control device according to claim 1,
wherein in the display content selection processing, the processor selects the one or more items of display content to make an area of one or more images indicating the one or more items of display content, and having a same size as an image that indicated same display content before the malfunctioning display was detected, no greater than an area of a display region of the one or more of the plurality of displays,
in the display position determination processing, the processor determines the display position of the one or more pieces of display content by determining a position in the one or more of the plurality of displays to cause a displacement of an image indicating the display content for which the tolerance level is lower among the one or more images to be smaller, the displacement being a displacement from a position at which an image indicating the corresponding one of the one or more items of display content had been displayed before the malfunctioning display was detected, and
in the display switching processing, the processor causes each of the one or more items of display content to be displayed at the display position of the corresponding one of the one or more items of display content by causing each of the one or more images to be displayed at the position determined.

3. The display control device according to claim 1,
wherein in the display content selection processing, the processor selects the one or more items of display content to make an area of one or more images indicating one or more items of display content, and at least one of which is a reduced image obtained by reducing an image that indicated same display content before the malfunctioning display was detected or a replacement image replacing the image that indicated the same display content before the malfunctioning display was detected, no greater than an area of a display region of the one or more of the plurality of displays,
in the display position determination processing, the processor determines the display position of the one or more pieces of display content by determining a position in the one or more of the plurality of displays to cause a displacement of an image indicating the display content for which the tolerance level is lower among the one or more images to be smaller, the displacement being a displacement from a position at which an image indicating the corresponding one of the one or more items of display content had been displayed before the malfunctioning display was detected, and
in the display switching processing, the processor causes each of the one or more items of display content to be displayed at the display position of the corresponding one of the one or more items of display content by causing each of the one or more images to be displayed at the position determined.

4. The display control device according to claim 1,
wherein in the display switching processing, when the malfunctioning display recovers, the processor causes each of the plurality of items of display content to be displayed at a position where the corresponding one of the plurality of items of display content had been displayed before the malfunctioning display was detected.

5. The display control device according to claim 1,
wherein the plurality of displays includes at least one of a display that is disposed in front of a driver's seat of a vehicle and that displays two or more items of display content among the plurality of items of display content, a display that is disposed in front of a passenger seat of the vehicle and that displays two or more items of display content among the plurality of items of display content, a display that is included in an electronic side mirror on a right side of the vehicle and that displays one item of display content among the plurality of items of display content, a display that is included in an electronic side mirror on a left side of the vehicle and that displays one item of display content among the plurality of items of display content, a display that is included in an electronic rear-view mirror of the vehicle and that displays one item of display content among the plurality of items of display content, or a display that is provided for a rear seat of the vehicle and that displays one or more items of display content among the plurality of items of display content.

6. A display control method performed by a computer, the display control method comprising:
detecting a malfunctioning display that has malfunctioned from among a plurality of displays;
when the malfunctioning display is detected, selecting, based on a priority level for display set for each of a plurality of items of display content displayed in the plurality of displays before the malfunctioning display was detected, one or more items of display content for which the priority level is higher among the plurality of items of display content;
determining, based on a tolerance level for a display position change set for each of the plurality of items of display content, a display position of each of the one or more items of display content in one or more of the plurality of displays aside from the malfunctioning display, to cause a displacement of display content for which the tolerance level is lower among the one or more pieces of display content to be smaller, the displacement being a displacement from a position at which a corresponding one of the one or more items of display content had been displayed before the malfunctioning display was detected; and
causing each of the one or more items of display content to be displayed at the display position of a corresponding one of the one or more items of display content.
